(19) United States
(12) Patent Application Publication
(10) Pub. No.: US 2006/0003196 A1
(43) Pub. Date: Jan. 5, 2006

(54) Fuel cell and electronic device equipped with the same

(76) Inventors: Ryuji Kohno, Kasumigaura (JP); Tatsuya Nagata, Ishioka (JP); Makoto Kitano, Tsuchiura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/171,218

(22) Filed: Jul. 1, 2005

(30) Foreign Application Priority Data
Jul. 1, 2004 (JP) 2004-195982

(51) Int. Cl. H01M 8/00

(52) U.S. Cl. 429/12; 429/34

(57) ABSTRACT

It is an object of the present invention to provide a fuel cell which can supply a liquid fuel, without changing its composition, to every corner of the membrane electrode assemblies arranged two- dimensionally over a wide area, to generate power at a high efficiency.

The fuel cell 10A comprises the membrane electrode assembly modules 20 which consume the liquid fuel 40 to generate power, and the fuel chamber 30 which holds the liquid fuel 40 inside and has the principal plane on which the membrane electrode assembly modules 20 are arranged, wherein the fuel chamber 30 is provided with the fuel injection hole 33 inside, through which the liquid fuel 40 is supplied under pressure from the outside, and the fuel supply gear 42 inside, which is located to come close to the membrane electrode assembly modules 20, the fuel supply gear 42 being provided, on the surface, with the fine pores 43 through which the liquid fuel 40 can pass.

### BACKGROUND OF THE INVENTION

The present invention relates to a fuel cell, in particular a fuel cell having one or more membrane electrode assembly modules, and electronic device equipped with the fuel cell.

Recently, direct methanol fuel cells (DMFCs), which directly use methanol as a liquid fuel to generate power, have been attracting attention as portable power sources capable of driving codeless devices, e.g., laptops, continuously for extended periods. Therefore, they are strongly demanded to be compacter for satisfying these purposes. As part of the efforts to satisfy these demands, various attempts have been made to develop fuel cells of reduced size or increased power output, e.g., arranging membrane electrode assemblies (MEAs) as power-generating elements two-dimensionally or electrically connecting them to each other in series.

FIG. 8 is a sectional view of conventional fuel cell.

The conventional fuel cell 1 comprises a plurality of membrane electrode assemblies 2 (five membrane electrode assemblies in the figure) arranged two-dimensionally with their anodes facing the fuel chamber 3, where the adjacent assemblies are electrically connected to each other in series, with the anode of one assembly connected to the cathode of the other assembly by the collecting plate 7.

The fuel chamber 3, which holds an aqueous methanol solution 4 as a liquid fuel, is provided with a number of holes 9 in the principal plane coming into contact with the membrane electrode assemblies 2. The aqueous methanol solution 4 moves upwards through the lifting member 5 to reach the holes 9 and come into contact with the anode of each membrane electrode assembly. This triggers the electrode reaction to generate a potential difference across the anode and cathode, producing power to be outputted to an external load. The aqueous methanol solution 4 is depleted as power is continuously outputted to an external load. However, the fuel cell is serviceable continuously for extended periods, because the aqueous methanol solution 4 is made up, as required, from the fuel supply device 6 (refer to, e.g., Patent Document 1). Patent Document 1 JP-A-2004-79506

### BRIEF SUMMARY OF THE INVENTION

The conventional fuel cell 1 involves the following problems. For example, a direct methanol fuel cell (DMFC) stoichiometrically needs a 50/50 by mol methanol/water mixture for the anode reaction. However, the aqueous solution of such a high methanol concentration, when used as a liquid fuel, will cause the crossover phenomenon, in which the membrane electrode assembly 2 passes more methanol molecules than water molecules to deteriorate activity on the air side, decreasing power output. Therefore, the fuel cell uses a much diluted solution containing methanol of about 10% to avoid the undesirable phenomenon.

The aqueous methanol solution 4 to be supplied to each of the membrane electrode assemblies 2 (five membrane electrode assemblies in the figure) is transferred via the supply pipe 8, shown in the left side in the figure, from the left side to the right side end. The aqueous methanol solution 4, initially containing methanol at a lower concentration than the stoichiometric level, further loses methanol concentration as it is consumed by the membrane electrode assemblies one by one, where methanol and water are consumed evenly. In other words, there is a methanol concentration distribution in the fuel chamber 3, the concentration at the starting point to which the supply pipe 8 is connected decreasing sequentially as the aqueous methanol solution 4 goes to the end.

Basically, the liquid fuel 4 has an optimum methanol concentration for maximizing power generating efficiency of a fuel cell. However, in a fuel cell with membrane electrode assemblies arranged two-dimensionally, uneven methanol concentration on a planar area will cause problems resulting from a lower than expected output even when fuel cell capacity is increased to produce high output.

The present invention is developed to solve these problems. It is an object of the present invention to provide a fuel cell which can supply a fuel of uniform concentration to its membrane electrode assemblies to generate power at a high efficiency.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1A shows a vertical sectional view illustrating basic structure of a fuel cell of the first embodiment.

FIG. 1B shows a vertical sectional view illustrating another fuel cell of the first embodiment.

FIG. 1C shows a vertical sectional view illustrating still another fuel cell of the first embodiment.

FIG. 1D shows a vertical sectional view illustrating still another fuel cell of the first embodiment.

FIG. 2 shows an oblique view of a membrane electrode assembly module for a fuel cell.

FIG. 3 shows horizontal sectional views of several fuel supply gear shapes.

FIG. 4 shows sectional views of several supply hole types, illustrating a by-product gas leaving as bubbles.

FIG. 5 is an oblique view of a disassembled fuel cell of the second embodiment.

FIG. 6 is an oblique view illustrating connection of membrane electrode assembly modules for a fuel cell of the second embodiment.

FIG. 7 is an oblique view of an electronic device of the present invention.

FIG. 8 shows a vertical sectional view of a conventional fuel cell.

### DESCRIPTION OF REFERENCE NUMERALS

10A, 10B, 10C, 10D and 10E: Fuel cell

20: Membrane electrode assembly module

21: Membrane electrode assembly

22: Electrolyte membrane

23a: Anode

23c: Cathode

24a: Collecting plate for anode

24c: Collecting plate for cathode

25a: Negative terminal

25c: Positive terminal

26a: Fuel hole

26c: Oxygen hole

30 (30A, 30B, 30C, 30D and 30E): Fuel chamber

31, 31e: Principal plane plate

32 (32E): Lid

33: Fuel injection hole

34: Discharge hole

35: Aperture

36 (36E): Gas-permeable membrane

37: Fuel separating membrane

38 (38a, 38b and 38c): Supply hole

39, 43: Fine pore

40 (40a and 40b): Liquid fuel

41: Fuel supply device

42, 42E: Fuel supply gear

50, 50E: Cell body

51: Cell partition

52: Inner space

53: Holding plate

54: Bolt

55: Supply hole

56: Communicating hole

P: Portable terminal (electronic device)

### DETAILED DESCRIPTION OF THE INVENTION

The present invention is developed to solve the problems involved in conventional fuel cells, where the fuel cell having a structure described in each claim first fills up the fuel supply gear totally with a fuel (e.g., aqueous methanol solution), supplied from the outside into the inner space of the fuel chamber, and then sends it via the fine pores to the membrane electrode assemblies from nearby supply holes for generating power. The fuel is not consumed by the membrane electrode assemblies (MEAs) while it is held in the fuel supply gear and has a uniform composition when it is released from the gear at any point.

The embodiments of the present invention are described by referring to the attached drawings.

### First Embodiment

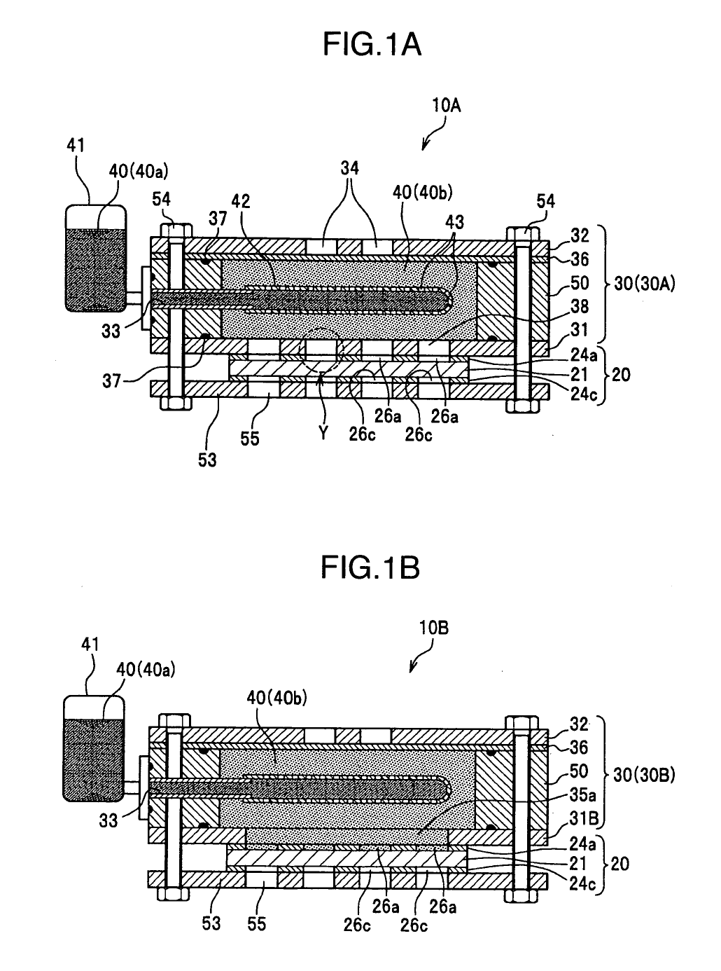

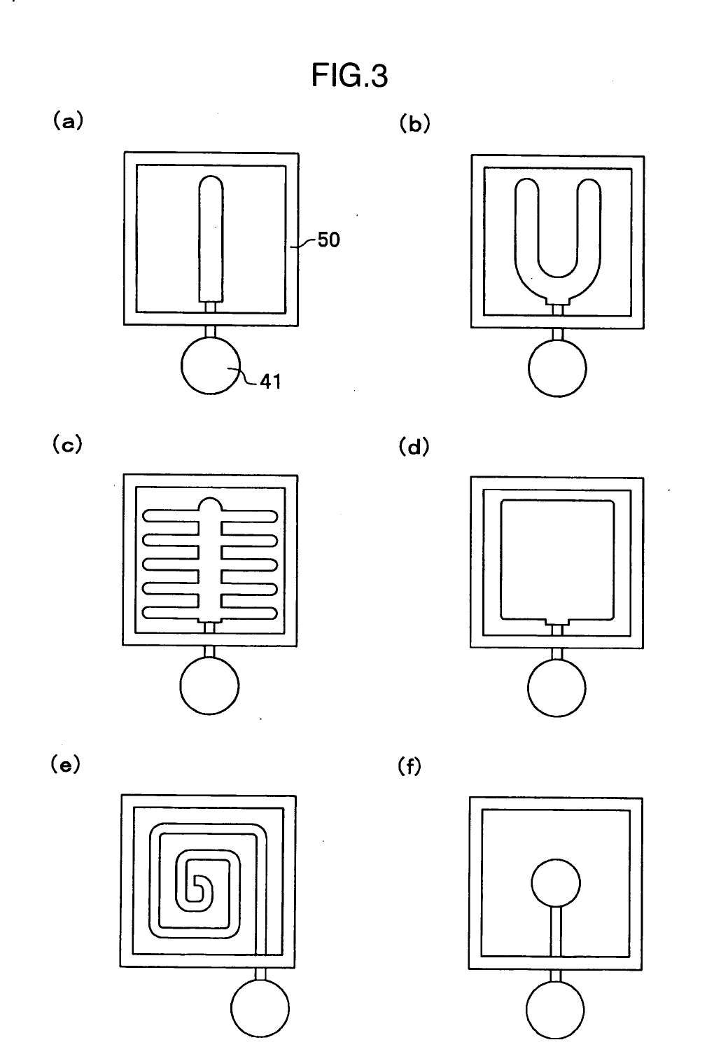

The first embodiment of the present invention is described by referring to from FIG. 1(A-D) to FIG. 4.

Referring to FIG. 1A, the fuel cell 10A is mainly composed of the membrane electrode assembly module 20 which consumes the liquid fuel 40 to generate power, fuel chamber 30A from which the liquid fuel 40 is supplied to the membrane electrode assembly module 20, fuel supply device 41 which holds the liquid fuel 40 outside of the fuel chamber 30A, fuel supply gear 42 which supplies the liquid fuel 40 from the fuel supply device 41 to the vicinity of each membrane electrode assembly module 20, and holding plate 53 which presses the membrane electrode assembly module 20 to, and fixes it on, the fuel chamber 30A. The fuel supply device 41 and fuel supply gear 42 are in communication with each other via the fuel injection hole 33, to send the liquid fuel 40 from the fuel supply device 41 to the fuel supply gear 42 under pressure.

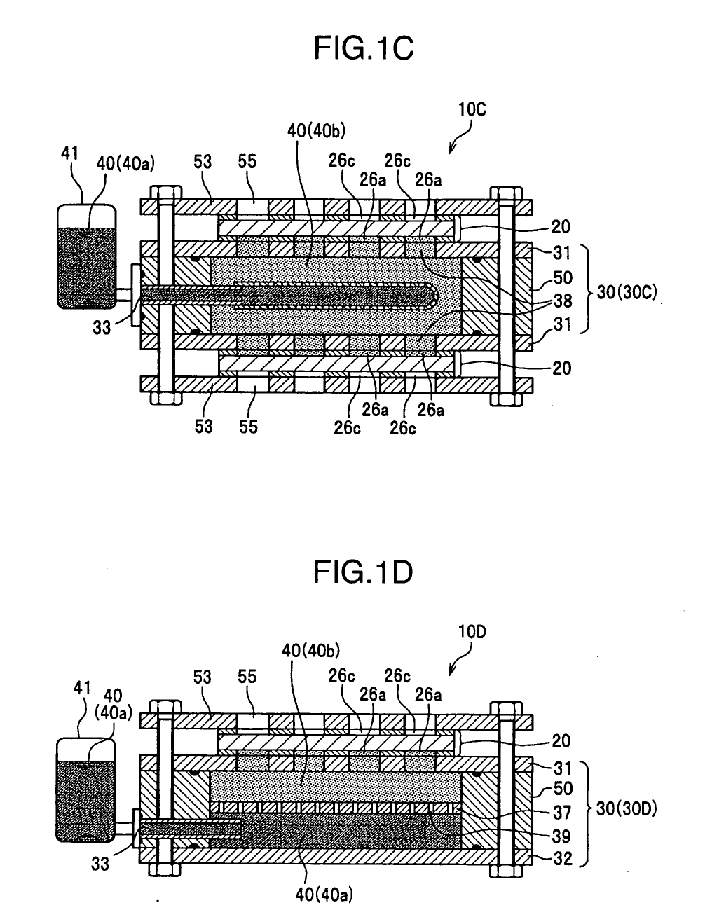

As illustrated in FIG. 2, the membrane electrode assembly module 20 is composed of the membrane electrode assembly 21 held between two collecting plates (collecting plate for anode 24a and collecting plate for cathode 24c).

The membrane electrode assembly module 21 is composed of the electrolytic membrane 22 held between the anode 23a and cathode 23c.

The collecting plate for anode 24a, placed on the anode 23a on the side opposite to the electrolytic membrane 22, is provided with a plurality of fuel holes 26a, by which the anode 23a is exposed to the outside.

On the other hand, the collecting plate for cathode 24c, placed on the cathode 23c on the side opposite to the electrolytic membrane 22, is provided with a plurality of oxygen holes 26c, by which the cathode 23c is exposed to the outside. It is preferable that these fuel holes 26a and oxygen holes 26c stand face to face with the electrolytic membrane 22 in-between, as illustrated in FIG. 2.

When the fuel cell 10A is of a type of direct methanol fuel cell (DMFC), each constitutional element for the membrane electrode assembly module 20 responsible for power generation exhibits the following function(s).

First, the anode 23a oxidizes methanol (liquid fuel 40) which comes into contact with the anode 23a to generate the hydrogen ions and electrons. It is composed of a mixture of catalyst of fine ruthenium/platinum alloy particles which are supported by fine carbon particles. The electrons generated move towards the collecting plate for anode 24a, from which they are transmitted to the outside via an interconnection (not shown).

The electrolytic membrane 22 transmits the hydrogen ions generated at the anode 23a towards the cathode 23c as the counter electrode, while blocking the electrons. It is composed, e.g., of a polyperfluorosulfonic acid resin, more specifically Nafion (trade mark)-or Aciplex (trade mark).

The cathode 23c works to reduce oxygen, moving through the oxygen holes to come into contact with the cathode 23c, with the electrons supplied from the collecting plate for cathode 24c, and to react the oxygen with the hydrogen ions moving from the electrolytic membrane 22. It is composed of a mixture of catalyst of fine platinum particles which are supported by fine carbon particles. The electrons required for the reduction are supplied from the collecting plate for cathode 24c via an interconnection (not shown).

The reactions occurring on the electrodes for the membrane electrode assembly 21, producing carbon dioxide as a by-product gas on the anode 23a and water as a by-product on the cathode 23c, are summarized below:

On the anode 23a
CH₃OH+H₂O→CO₂+6H⁺+6e⁻ (1)
On the cathode 23c
3/2O₂+6H⁺+6e⁻→3H₂O (2)
Total reaction
CH₃OH+3/2O₂→CO₂+2H₂O (3)

The liquid fuel 40 (refer to FIG. 1A) is an aqueous methanol solution, as described earlier. The fuel present in the inner space extending from the fuel supply device 41 to the fuel supply gear 42 is marked with 40a, and that present in the fuel chamber 30 but outside of the fuel supply gear 42 is marked with 40b for convenience to distinguish them from each other. The liquid fuel 40b held in the fuel chamber 30 is diluted to have a significantly lower methanol concentration (about 10%) than the stoichiometric ratio (50/50 by mol) to avoid the above-described crossover phenomenon, which can decrease power output. However, methanol and water are actually consumed on the anode 23a in a ratio close to the stoichiometric level, with the result that the liquid fuel 40b in the fuel chamber 30 gradually loses its methanol concentration. Therefore, it is necessary for the make-up liquid fuel 40a to have a higher methanol concentration than the liquid fuel 40b, preferably a stoichiometric concentration at which the liquid fuel is actually consumed on the anode 23a.

The above structure allows the liquid fuel 40b in the fuel chamber 30 to be kept at a methanol concentration needed to continuously secure power generation at a maximum output, even when it is diluted, because the liquid fuel 40a of higher concentration is sequentially supplied from the fuel supply device 41. The methanol concentration which can continuously secure power generation at a maximum output, set at around 10% for the above structure, widely varies depending on the constitutional elements for the membrane electrode assembly module 20. At the same time, the liquid fuel 40a in the fuel supply device 41 can have a methanol concentration much lower than the stoichiometric level, in consideration that a fairly large quantity of water passes through the membrane electrode assembly 21. Therefore, there may be cases where need for distinguishing the liquid fuels 40b from each other is essentially saved.

The fuel chamber 30 is composed of the cell body 50, principal plane plate 31 and lid 32 as shown in FIG. 1A, and is filled with the liquid fuel 40b in its internal space to work to supply the fuel 40b to the membrane electrode assembly module 20.

The cell body is cylindrical in shape with the principal plane plate 31 and lid 32 at the ends, to form the inner space to be filled with the liquid fuel 40. It is provided with the O-rings 37 at each end, with which the principal plane plate 31 or lid 32 is in contact, to seal the inner space and prevent leakage of the liquid fuel 40b.

The cell body 50 is provided, on one lateral side, with the fuel injection hole 33 through which the liquid fuel 40a is passed into the inner space of the fuel chamber 30 from the fuel supply device 41 outside.

Moreover, the fuel supply gear 42, which is in communication with the fuel injection hole 33, is provided in the inner space of the fuel chamber 30 in such a way to come close to the membrane electrode assembly modules 20. The fuel supply gear 42 is provided, on the surface, with a number of fine pores 43 through which the liquid fuel 40a can pass.

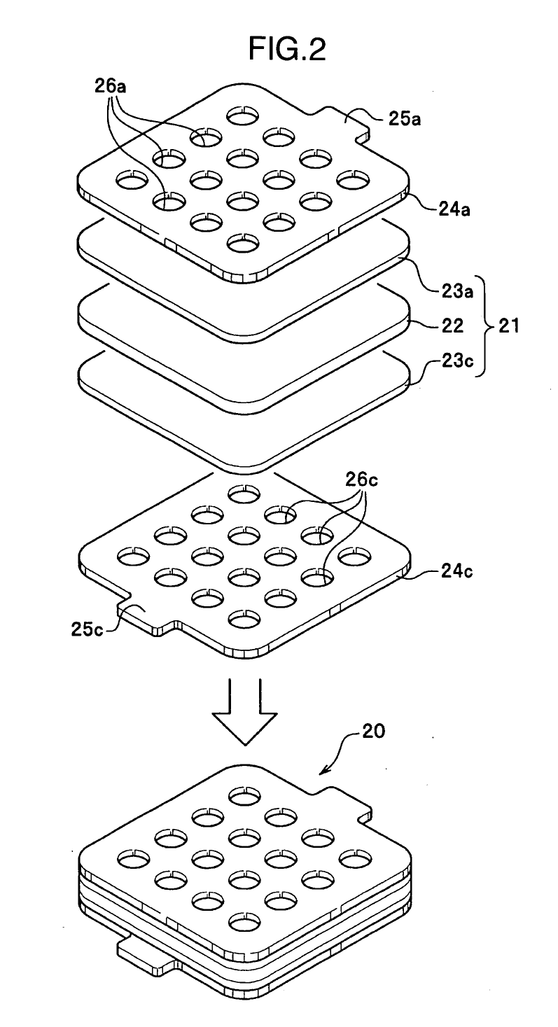

The fuel supply gear 42 preferably has a shape to cover a wide area over the principal plane plate 31 so that the liquid fuel 40 leaving the fine pores 43 can be uniformly supplied to the membrane electrode assembly module 20 surfaces. FIG. 3 shows several shapes which the fuel supply gear 42 can take; (a) I-shape, (b) U-shape, (c) fishbone, (d) wide rectangle, (e) volute and (f) shape having a ball in the center.

The fuel supply gear 42 may be a varying material, e.g., porous ceramic, hard resin, metal or soft resin film formed into a bag shape. The fine pores 43 provided on the fuel supply gear 42 surface preferably have a controlled size and are adequately arranged to uniformly release the liquid fuel 40a sent from the fuel injection hole 33 under a given pressure. More specifically, the fine pores 43 have a diameter of 0.1 to 100 μm, preferably around 1 μm in actuality, and are arranged to secure a porosity of 20 to 85%.

The fine pores 43 shown in FIG. 1 are arranged at the same density over the entire fuel supply gear 42 surface. However, other arrangements can be adopted. For example, they may be arranged more densely on the membrane electrode assembly module 20 side. The fuel supply gear 42 having the above shape and arrangement can minimize concentration distribution of the liquid fuel 40 in the fuel chamber 30.

The fuel supply device 41 sends the liquid fuel 40a which it holds, injecting it under a pressure of 1 atm. or more into the inner space of the fuel chamber 30 from the fuel injection hole 33 (refer to FIG. 1A). The liquid fuel 40a to be injected may be pressurized by various means. For example, it may be forced out of the fuel supply device 41 by a freely movable piston driven by an elastic spring, both provided in the device 41 inside, or by a pressure gas evolving in the device 41 inside. These means are not described in detail in this specification.

The principal plane plate 31 serves as a main side of the fuel chamber 30, and is provided with a plurality of supply holes 38 which correspond to a plurality of the fuel pores 26a provided on the membrane electrode assembly module 20 coming into contact with the plate 31. The liquid fuel 40b held in the inner space of the fuel chamber 30 is sent to the anode 23a, exposed through the fuel holes 26a, via the supply holes 38.

When the principal plane plate 31 is made of an electroconductive material, e.g., metal, it is necessary to provide an insulation membrane (not shown) in the interface between the plate 31 and collecting plate for anode 24a. This is to prevent the electrons generated on the anode 23a from running out through the fuel chamber 30.

FIG. 4 (a) to (c) are sectional views illustrating several types of the supply hole 38 (38a, 38b and 38c), each of which is an enlarged section indicated by the arrow Y in FIG. 1A. It shows how the by-product gas bubbles evolved by the power-generating reaction on the anode 23a grow in each type of the supply hole 38 step by step in Steps 1 to 4.

FIG. 4 (a) illustrates growth of the bubbles in the supply hole 38a having a rectangular section. The fine bubbles evolving on the anode 23a grow in the lateral direction while repeatedly coalescing with each other and expanding (Step 1). The grown bubble comes to totally cover the anode 23a portion exposed through the supply hole 38 (Step 2). Then, it grows vertically (Step 3), and comes off from the supply hole 38 by buoyancy (Step 4). The supply hole 38 may no longer contribute to power generation, when covered with the bubble(s) semi-permanently.

The supply holes 38b and 38c in FIG. 4 (b) and (c) have a tapered section flaring towards the inner space of the fuel chamber 30, in a straight line (38b) or curved line (38c). In the tapered supply hole, 38b or 38c, the bubbles grow similarly in Steps 1 and 2, but move away from the hole more quickly in Steps 3 and 4 while they are growing vertically, leaving behind no residual component. Therefore, shut-down of power generation at the hole for extended periods can be avoided.

The anode 23a, exposed through the fuel holes 26a, is surface-treated by a known method to be hydrophilic from its surface to the inner surface of each of the supply holes 38. This prevents the formed bubbles from remaining on the surface for extended periods, allowing them to move away in a shorter time.

Returning back to FIG. 1A, the description is continued.

The holding plate 53 is placed on the side of the collecting plate for cathode 24c in the membrane electrode assembly module 20, and is provided with a plurality of the supply and discharge holes 55 which are in communication with a plurality of the oxygen holes 26c to take air (oxygen) into the module 20. It is clamped to the fuel chamber 30 by a plurality of bolts 54 (2 in the figure) running through the cell body 50 to hold the membrane electrode assembly module 20 in-between. This presses the membrane electrode assembly module 20 to the principal plane plate 31 under a uniformly distributed surface pressure provided by the holding plate. As a result, the principal plane plate 33 and collecting plate 24a for anode come into contact closely with each other to have a tight interface, preventing leakage of the liquid fuel 40b from the supply holes 38 to the outside.

When the holding plate 53 is made of an electroconductive material, e.g., metal, it is necessary to provide an insulation membrane (not shown) in the interface between the holding plate 53 and collecting plate 24c for cathode. This is to prevent the hydrogen ions from being neutralized by the electrons flowing into from the outside.

The discharge holes 34 are provided each at a position in the inner space of the fuel chamber 30, where the by-product gas (carbon dioxide) discharged from the fuel holes 26 in the membrane electrode assembly module 20 is collected. They are opened in the direction of buoyancy. Therefore, they are provided in the central part of the lid 32 in the structure shown in FIG. 1A. However, their position is not limited to the above. For example, one or more holes may be provided at any position(s) in the fuel chamber 30, depending on various conditions, e.g., direction in which the fuel cell 10A is installed. Moreover, the discharge hole 34 is provided with the gas-permeable membrane 36 which can allow carbon dioxide to pass while blocking the liquid fuel 40b.

More specifically, the gas-permeable membrane 36 may be in the form of woven fabric, non-woven fabric, net, felt or the like, made of continuously porous polytetrafluoroethylene (expanded PTFE), e.g., GORE-TEX (trade mark).

Providing the discharge hole 34 with the gas-permeable membrane 36 allows the by-product gas to be selectively discharged while tightly sealing the liquid fuel 40b in the fuel chamber 30. The gas-permeable membrane 36, which allows the by-product gas to pass while blocking the liquid fuel, prevents leakage of the liquid fuel from the fuel chamber, even when the fuel cell is inclined while the surface of the liquid fuel is in contact with the discharge hole. The gas-permeable membrane 36 shown in FIG. 1A totally covers one side of the lid 32. However, the structure is not limited to the above, so long as it covers the discharge hole 34 openings.

Next, the other fuel cell types of the first embodiment are described by referring to FIG. 1B to 1D.

The fuel cell 10B shown in FIG. 1B is provided with the supply and discharge hole 38a, in place of the supply holes 38 for the cell shown in FIG. 1A, through which a plurality of the fuel holes 26a are exposed, where the hole 38a has an opening area comparable to the total opening areas of the holes 38.

FIG. 4 (d) shows the process of the by-product gas bubbles moving away from the collecting plate 23a for anode in the fuel cell 10B. They move away quickly leaving behind no residual component to avoid shut-down of power generation at the hole for extended periods, as is the case shown in FIG. 4 (b) or (c).

The fuel cell 10C shown in FIG. 1C is provided with the membrane electrode assembly modules 20 on both sides of the fuel chamber 30. It can double power output while keeping its volume unchanged. The discharge holes, although not shown in the figure, are provided at adequate positions.

The fuel cell 10D shown in FIG. 1D is provided with the fuel separating membrane 37 in place of the fuel supply gear 42 for the cell shown in FIG. 1A. The fuel separating membrane 37 divides the fuel chamber 30D inside in the direction almost in parallel to the principal plane plate 31, and is provided with the fine pores 39 through which the liquid fuel can pass. The fuel injection hole 33 is provided in the fuel chamber 30 in the divided space on the lid 32 side.

The fuel cell of the first embodiment, described above, totally fills the fuel supply gear 42, provided in the fuel chamber 30, with the liquid fuel (e.g., aqueous methanol solution) charged under pressure to the fuel chamber 30 via the fuel injection hole 33 from the fuel supply device 41 outside. The fuel is not consumed by the membrane electrode assemblies (MEAs) while it is spreading into every corner of the fuel supply gear 42, and has a uniform composition at any point. The liquid fuel 40 filling the fuel supply gear 42 inside is supplied, via the fine pores 43 provided on the fuel supply gear 42 surface, to the exposed anode 26a from the near-by supply holes 38 for power generation. The liquid fuel 40 is not consumed while it is moving from the fuel injection hole 33 to the supply holes 38, although they are removed from the hole 33, keeping its composition unchanged. The tapered structure of the supply hole 38 allows the by-product gas formed by the power-generating reaction to move away from the anode 26a in a very short time. Therefore, the fuel cell can generate power constantly at a high efficiency, even when it is in service for extended periods.

### Second Embodiment

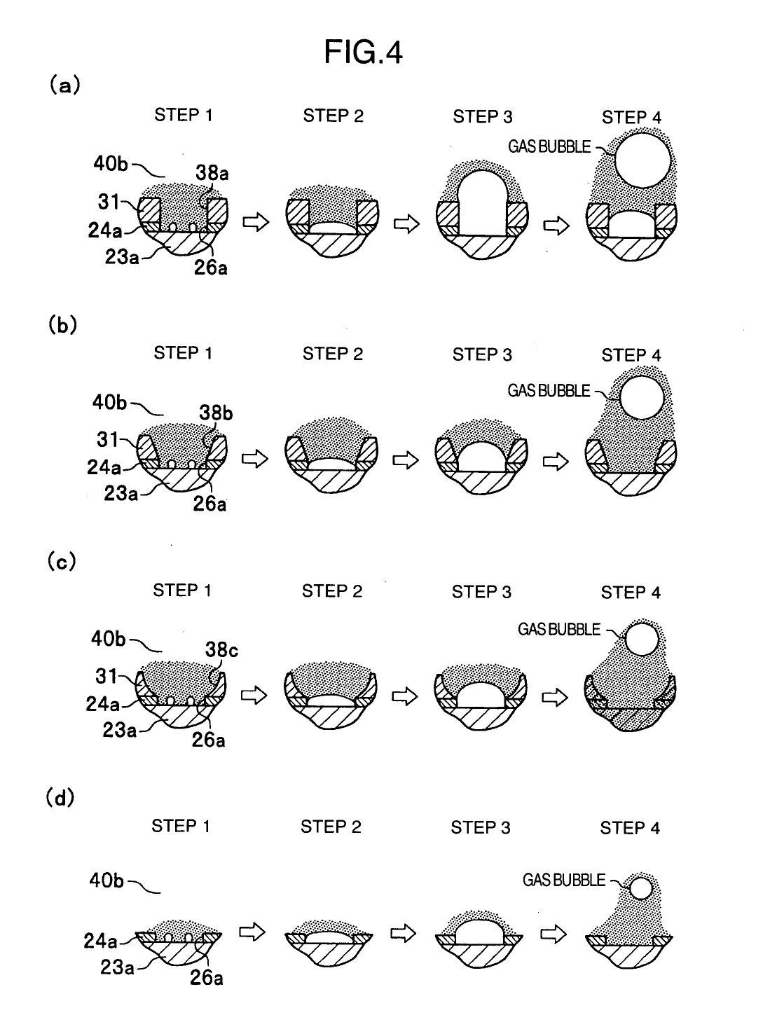

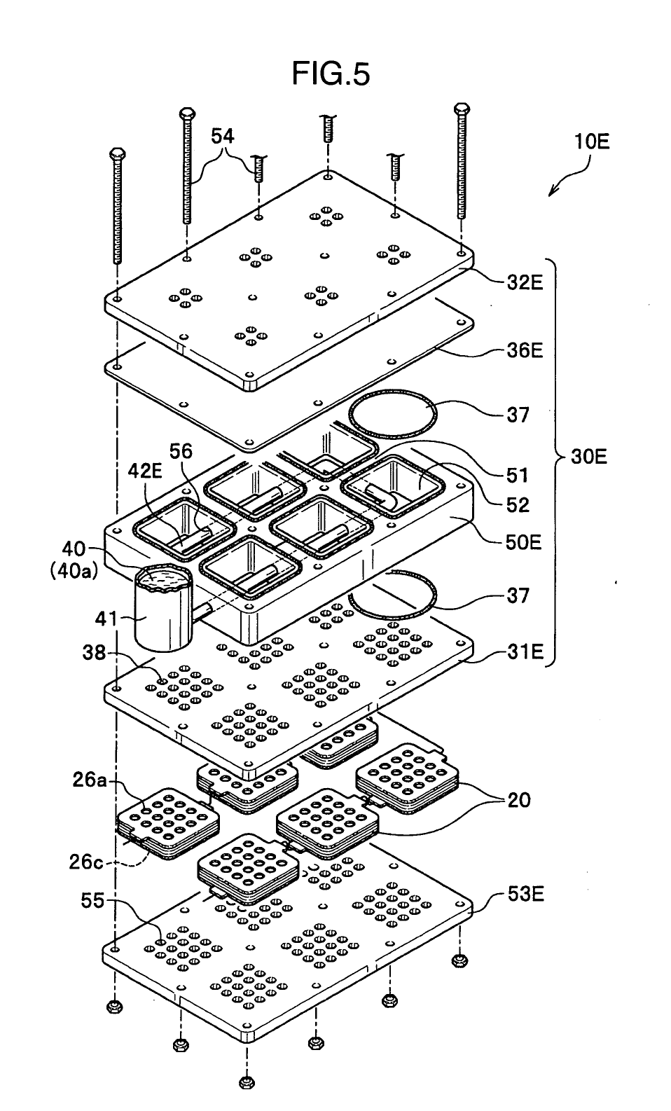

Next, the other fuel cell types of the second embodiment are described by referring to FIGS. 5 and 6.

As shown in FIG. 5, the fuel cell 10E of this embodiment has a plurality of the membrane electrode assembly modules 20 which are electrically connected to each other in series or parallel and arranged two-dimensionally on the principal plane plate 31E for the fuel chamber 30E.

A plurality of the membrane electrode assembly modules 20 shown in FIG. 6 are connected to each other in series, where the negative terminal 25a of the membrane electrode assembly module 20 is connected to the positive terminal 25c of the adjacent module 20 to establish the series circuit as a whole. The line of the modules 27 is provided with interconnections at both ends to transmit power output to the outside.

When a plurality of the membrane electrode assembly modules 20 are connected in parallel, the collecting plates for anode 24a of the adjacent modules 20B are connected to each other, and so are the collecting plates 24c for cathode, although the detailed description is omitted.

The cell body 50E is provided with a plurality of the inner spaces 52, each at a position to correspond to the pairing membrane electrode assembly module 20 and separated from the adjacent one by the cell partition 51, as shown in FIG. 5. Moreover, each of the cell partitions 51 is provided with the communicating hole 56 which allows the fuel supply gear 42E to run through all of the inner spaces 52. Therefore, the liquid fuel 40a can be distributed from the fuel supply device 41 to each of the inner spaces 52 while keeping its methanol concentration unchanged.

Moreover, the principal plane plate 31E and holding plate 53E are provided with a plurality of the fuel holes 26a and oxygen holes 26c, respectively, which are corresponding to the respective supply holes 38 and supply and discharge holes 55. The lid 32E, gas-permeable membrane 36E, cell body 50E, principal plane plate 31E, membrane electrode assembly module 20 and holding plate 53E, provided in this order, are clamped to each other by a plurality of the bolts 54 running through them.

Each of the cell partitions 51 is located between the adjacent membrane electrode assembly modules 20, which allows the bolt(s) 54 to run therethrough, and hence allows the membrane electrode assembly module 20 peripheries to be clamped symmetrically. As a result, a surface pressure is uniformly applied to the membrane electrode assembly modules 20. Application of a uniform surface pressure is expected to bring several favorable effects, e.g., decreased contact resistance between the membrane electrode assembly 21 (refer to FIG. 2) and collecting plate 24a for anode or collecting plate for cathode 24c, and improved contact between the principal plane plate 31 and membrane electrode assembly module 20 to prevent the liquid fuel 40 flowing from the supply holes 38 from leaking through the interface between them.

Presence of the cell partitions 51 can increase flexural rigidity of the fuel cell 10E, which can contribute to solving the problems of reduced flexural rigidity, occurring when number of the membrane electrode assembly modules 20 is increased to increase cell power output, because this decreases relative cell thickness in the width direction (or height).

The inner spaces 52 are arranged two-dimensionally in the lateral direction in FIG. 5. However, they may be arranged in the vertical direction to form a stacked structure for the fuel cell.

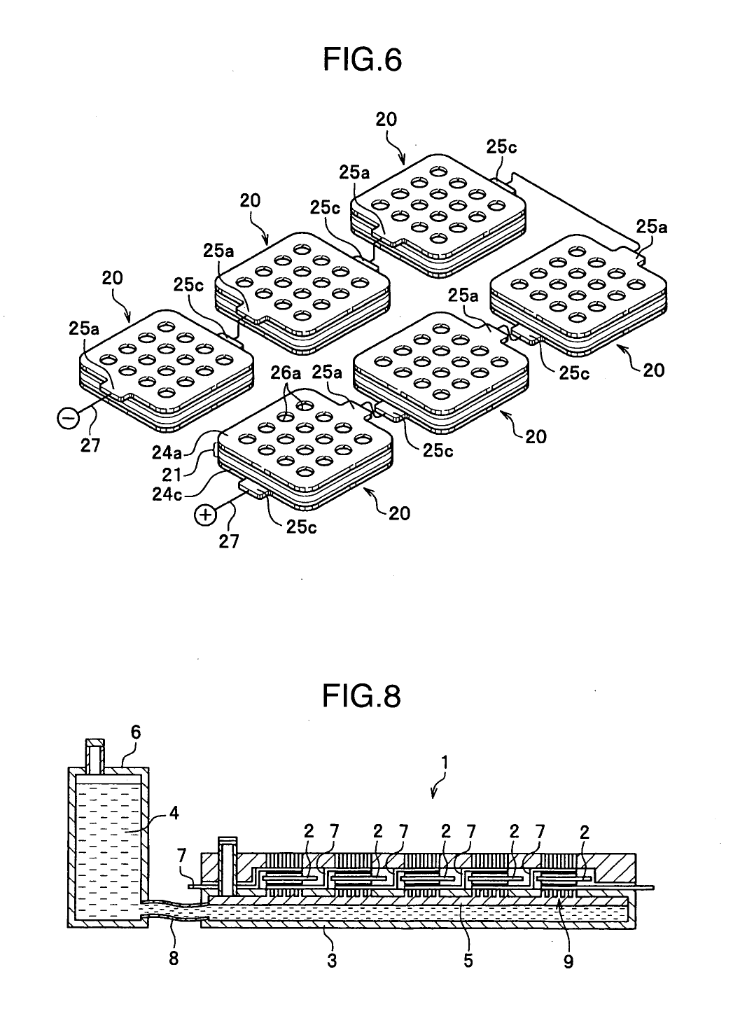

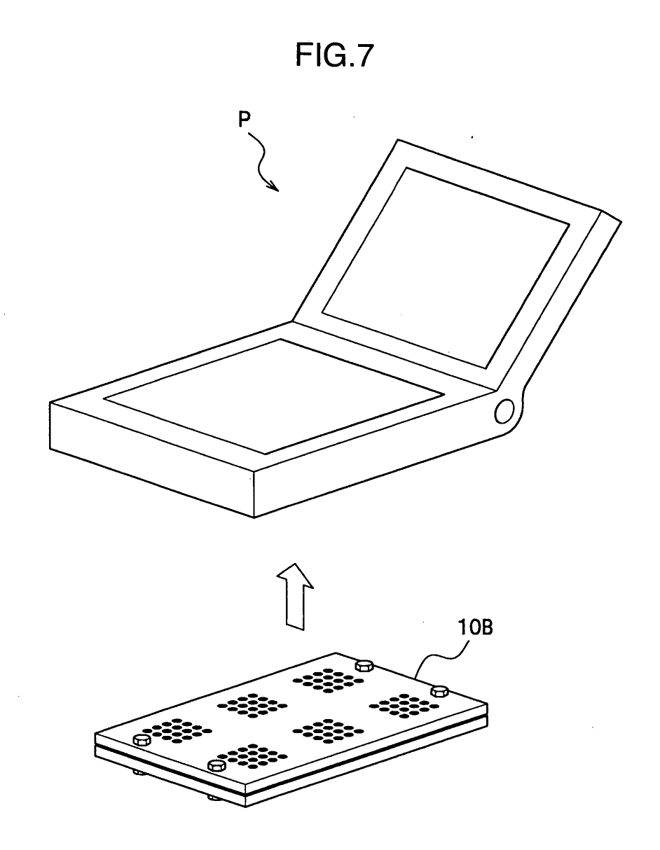

FIG. 7 shows an oblique view illustrating the portable terminal P as an electronic device of the present invention, equipped with the fuel cell 10E of the second embodiment. The portable terminal P is generally required to be light, compact and serviceable for extended periods, even when it consumes much power. The fuel cell 10E, which can satisfy the above requirements, can be an optimum power source for the portable terminal P. The electronic device of the present invention covers a wide concept, including a portable terminal shown in FIG. 7 and other portable devices, e.g., cellular phones, PDAs and laptops, and indoor-outdoor devices, e.g., game devices.

The fuel cell of the second embodiment described above, which is required to be compact and generate high output, can spread a liquid fuel of constant composition into every corner of the membrane electrode assembly module 20, even when the area for the modules 20 is expanded to increase power output. Moreover, the by-product gas evolved by the power-generating reaction can move away from the anode in a very short time. Therefore, the fuel cell can generate power constantly at a high efficiency, even when it is in service for extended periods.

The present invention is described on the basis that the fuel cell is of a direct methanol fuel cell type. Therefore, it is provided with the discharge hole 34 (refer to FIG. 1) as an essential component for discharging the by-product gas (carbon dioxide) evolving on the anode 23a. It is to be understood, however, that a structure in which the discharge hole 34 is not an essential component is also within the technical scope of the present invention, in expectation that a combination of liquid fuel 40 and membrane electrode assembly 21 may be developed in the future to evolve no by-product gas on the anode 23a. It is also to be understood that the technical scope of the present invention is directly applicable to a fuel cell which uses a gas fuel, because it can contribute to solving the similar problems involved in gas fuels.

It should be further understood by those skilled in the art that although the foregoing description has been made on embodiments of the invention, the invention is not limited thereto and various changes and modifications may be made without departing from the spirit of the invention and the scope of the appended claims.

### Advantages of the Invention

The present invention can generate power at a high efficiency, because it can supply a fuel of uniform composition to the membrane electrode assembly module at any point.

1. A fuel cell comprising:
a membrane electrode assembly module comprising
a membrane electrode assembly for oxidizing a fuel on its anode and reducing oxygen on its cathode to generate power,
a collecting plate for anode of the membrane electrode assembly, located on the anode side, for transmitting the electrons generated by the oxidation, and
a collecting plate for cathode of the membrane electrode assembly, located on the cathode side, for supplying the electrons needed for the reduction, and
a fuel chamber, located on the anode side of the membrane electrode assembly module, for supplying the fuel which it holds in its inner space to the membrane electrode assembly, wherein the fuel cell is further provided with
a fuel injection hole, located in the fuel chamber, for supplying the fuel from the outside into the inner space, and
a fuel supply gear, having fine pores on the surface through which the fuel can pass, in the inner space in such a way to be in communication with the fuel injection hole, and
wherein the fuel is supplied from the outside through the fine pores to make up the fuel consumed by the oxidation.

2. A fuel cell comprising:
a membrane electrode assembly module comprising
a membrane electrode assembly for oxidizing a fuel on its anode and reducing oxygen on its cathode to generate power,
a collecting plate for anode of the membrane electrode assembly, located on the anode side, for transmitting the electrons generated by the oxidation, and
a collecting plate for cathode of the membrane electrode assembly, located on the cathode side, for supplying the electrons needed for the reduction, and
a fuel chamber, located on the anode side of the membrane electrode assembly module, for supplying the fuel which it holds in its inner space to the membrane electrode assembly, wherein the fuel cell is further provided with
a fuel separating membrane having fine pores on the surface through which the fuel can pass, located in the inner space for dividing the inner space in the direction almost in parallel to the membrane electrode assembly module, and
a fuel injection hole, located in the fuel chamber in the divided space on the side opposite to the membrane electrode assembly module, for supplying the fuel through the fine pores from the outside of the fuel chamber, and
wherein the fuel is supplied from the outside through the fine pores to make up the fuel consumed by the oxidation.

3. The fuel cell according to claim 1 or 2, wherein the fuel chamber is provided, in the plane in contact with the membrane electrode assembly module, with supply holes through which the fuel is supplied to the membrane electrode assembly module,
wherein each of the supply holes has a tapered section flaring towards the inner space.

4. The fuel cell according to claim 3, wherein the supply holes are surface-treated to be hydrophilic.

5. The fuel cell according to claim 1 or 2, wherein the fuel chamber is provided with the discharge holes for discharging the by-product gas evolved by the oxidation reaction and collected in the inner space, and
wherein each of the discharge holes is provided with a gas-permeable membrane which allows the by-product gas to be discharged while blocking the liquid fuel.

6. The fuel cell according to claim 1 or 2, wherein the membrane electrode assembly modules are electrically connected to each other in parallel or series, and arranged two-dimensionally on the fuel chamber.

7. The fuel cell according to claim 6, wherein the fuel chamber is divided into the inner spaces, each at a position to correspond to the pairing membrane electrode assembly module, by the cell partitions, and
wherein each of the cell partitions is provided with a communicating hole which allows the fuel supply gear to run through all of the inner spaces.

8. An electronic device equipped with the fuel cell according to claim 1 or 2.
